(19) United States
(12) Patent Application Publication
(10) Pub. No.: US 2006/0267540 A1
(43) Pub. Date: Nov. 30, 2006

(54) PUMP DRIVEN BY DUAL WOUND VARIABLE FREQUENCY INDUCTION MOTOR

(75) Inventors: James Chu, Westlake, OH (US); Thomas Sailer, Amherst, OH (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: PARKER HANNIFIN CORPORATION, Cleveland, OH (US)

(21) Appl. No.: 11/279,789

(22) Filed: Apr. 14, 2006

Related U.S. Application Data
(60) Provisional application No. 60/685,506, filed on May 27, 2005.

(51) Int. Cl. H02P 1/16

(52) U.S. Cl. 318/778

(57) ABSTRACT

An electrically operated pump assembly operable on a variable frequency power source includes a pump having an input shaft, and a variable frequency motor operatively coupled to the input shaft. The variable frequency motor includes a first winding having a first number of poles, and a second winding having a second number of poles, wherein the first winding is selectively energizable in a first frequency range of the predetermined frequency range, and the second winding is selectively energizable in a second frequency range of the predetermined frequency range.

### RELATED APPLICATION DATA

This application claims priority of U.S. Provisional Application No. 60/685,506 filed on May 27, 2005, which is incorporated herein by reference in its entirety.

### FIELD OF THE INVENTION

The present invention relates generally to pumps and, more specifically, to a pump driven by a dual wound variable frequency induction motor.

### BACKGROUND OF THE INVENTION

In the aerospace industry, pumps of various types are used to deliver fluids, such as fuel, throughout an aircraft. Generally, these pumps are driven by electric motors operating on AC power.

With reference to FIG. 1A, some aerospace applications utilize a fixed frequency AC power system 10, which includes an alternator 12 driven by an aircraft's main propulsion system 14. More specifically, a constant speed drive 16 couples the propulsion system 14 to the alternator 12, wherein an output rotational speed of the constant speed drive 16 remains substantially constant while an input rotational speed of the constant speed drive 16 varies with the speed of the propulsion system 14. The alternator 12, being coupled to the output of the constant speed drive 16, generates fixed frequency three phase AC power (e.g., about 400 Hz). Coupled to the power system 10 is a multi-speed pump 18 (e.g., a fuel pump), which is driven by a fixed frequency dual wound AC induction motor 20. As is well known by those skilled in the art, a fixed frequency dual wound induction motor may include a rotor and two separately wound stators. In effect, the fixed frequency dual wound induction motor is two motors in one, each of equal power, and can operate at any two speeds. The fixed frequency dual wound motor 20 drives an impeller 22 of the pump 18 so as to move the fluid. By selectively switching between the two stator windings (e.g., via contactors N1 and N2), two different motor speeds (and thus two different pump speeds) can be achieved.

Other aerospace applications have utilized variable frequency power generating systems 30, as shown in the exemplary system of FIG. 1B. In such systems, the constant speed drive is removed from the system, and the alternator 12 is driven by the propulsion system 14 (e.g., via a gear box—not shown). Such systems generally generate AC power having a frequency range between about 360 Hz to about 720 Hz (and sometimes up to about 800 Hz). Further, the pump 32 is driven by a variable frequency AC induction motor 34, which in turn drives the impeller 22. Variable frequency induction motors can operate over a large frequency range to provide a relatively constant speed (e.g., via high slip) or variable speed (e.g., via low slip). Due to the wide frequency range employed in aerospace applications and the fact that power output of an induction motor drops off as the input frequency increases above the motor rated frequency, such motors typically are oversized to enable operation over the entire frequency range. Oversizing the motor, however, results in a low power factor in the low frequency range (and thus increased power consumption).

Further, the output hydraulic pressure of a centrifugal pump, for example, increases in proportion to the square of the operating speed. Therefore, if the motor is designed such that speed increases in proportion to input frequency (e.g., a low slip motor), there is an unacceptable increase in input power at high frequencies. Thus, a careful tradeoff is required in the design of pump based variable frequency AC induction motors to optimize the amount of slip at high frequencies and to maintain a reasonable power factor at low frequencies so that efficiencies are optimized and overall power consumption is minimized over the operating frequency range.

In newer commercial aircraft, a known power generation system 30 produces variable frequency AC power, wherein the frequency range can exceed a ratio of 2:1 (e.g., 360 Hz to 720 Hz, and in some cases up to 800 Hz). For small motors (small pumps), the low power factor at low frequencies and inefficiencies at high frequencies are acceptable, since they are considered reasonable tradeoffs for achieving variable frequency operation using simple and reliable components. As motor size increases, however, the power factor and efficiency can become an issue at the extreme portions of the frequency range.

One approach to addressing the above issues has been to implement brushless DC motors driven by electronic motor controllers, as shown in FIG. 1C. For example, the pump 36 includes an integral electronic motor controller 38 and a brushless DC motor 40 coupled to the impeller 22. The controller 38 generates a pulse width modulated (PWM) signal, which is applied to the motor 40. By varying the PWM signal, motor speed and, thus, impeller speed can be controlled. While such controller based systems are efficient relative to conventional high-slip induction motor based systems, they are complex, heavy and much less reliable than conventional systems.

### SUMMARY OF THE INVENTION

The present invention enables a pump, such as a fuel pump, to operate efficiently over a relatively constant speed range using a variable frequency AC power source. The pump is driven by a multi-wound variable frequency motor, which enables different windings to be selected over the application frequency range. A low frequency winding can be selected to operate in a low frequency range, while a high frequency winding can be selected to operate in a high frequency range. The invention provides a highly reliable pump drive that has good power factor and efficiencies through the entire frequency range.

According to one aspect of the invention, there is provided an electrically operated pump assembly operable on a variable frequency power source, said power source producing power in a predetermined frequency range. The pump assembly includes a pump having an input shaft, and a variable frequency motor operatively coupled to the input shaft. The variable frequency motor comprises a first winding having a first number of poles, and a second winding having a second number of poles, wherein the first winding is selectively energizable in a first frequency range of the predetermined frequency range, and the second winding is selectively energizable in a second frequency range of the predetermined frequency range.

According to another aspect of the invention there is provided a method of driving a pump via a multi-wound variable frequency electrical motor operable on a variable frequency power source, the variable frequency power source producing power in a predetermined frequency range. Variable frequency power is provided to the multi-wound variable frequency electrical motor, and a first winding of the motor is selectively energized in a first frequency range of the predetermined frequency range, and a second winding of the motor is selectively energized in a second frequency range of the predetermined frequency range.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

### BRIEF DESCRIPTION OF THE DRAWINGS

The forgoing and other embodiments of the invention are hereinafter discussed with reference to the drawings.

FIG. 1A is a schematic diagram of a prior art pump and AC motor with dual speed stator windings operating on fixed frequency AC power.

FIG. 1B is a schematic diagram of a prior art pump and AC motor operating on variable frequency AC power.

FIG. 1C is a schematic diagram of a prior art pump and brushless DC motor operating on variable frequency AC power.

FIG. 2 is a schematic diagram of an exemplary fuel system of an aircraft.

FIG. 3A is a schematic diagram of an exemplary pump incorporating a dual wound variable frequency AC motor in accordance with the invention.

FIG. 3B is a schematic diagram showing the dual stator windings of the motor of FIG. 2A.

FIGS. 4A and 4B are torque-speed graphs of exemplary dual wound 6 and 8 pole motors in accordance with the invention.

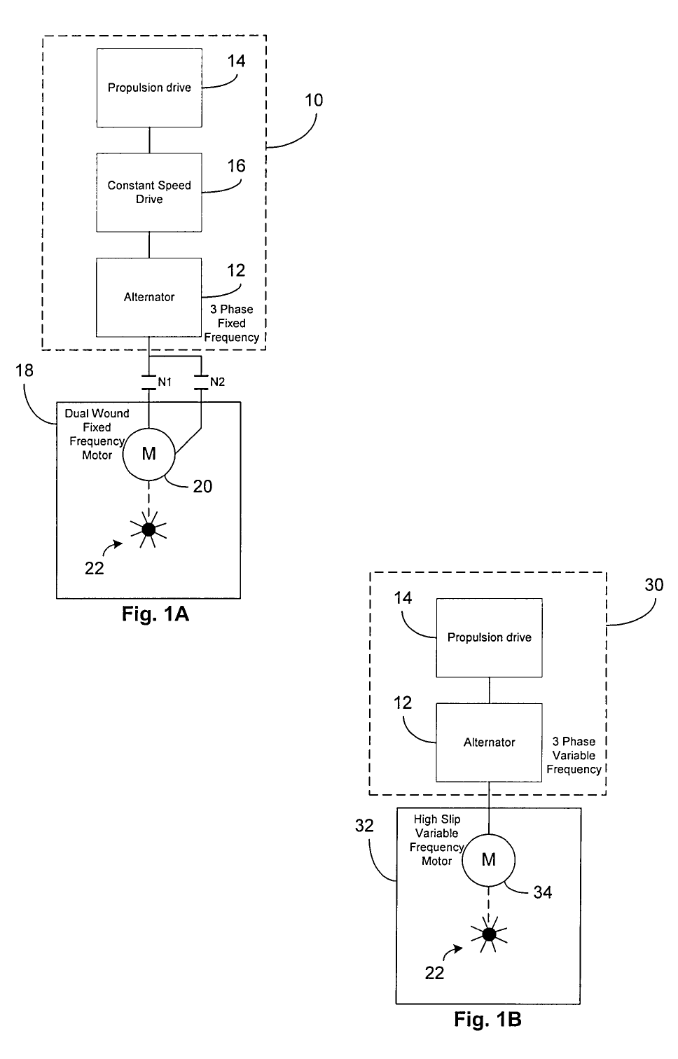

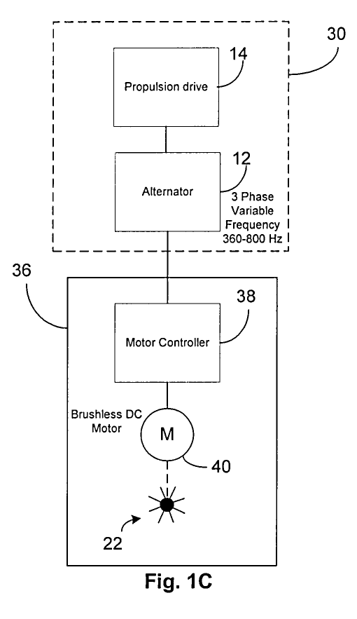

### DETAILED DESCRIPTION

The present invention enables a pump to be simply and efficiently operated over a wide frequency range while maintaining a relatively constant speed. The pump, which may be a fuel pump, coolant pump, or any other pump utilized to move or pressurize a fluid, is driven by a variable frequency AC motor. The variable frequency AC motor is a dual-wound motor that includes a first or low frequency winding having a first number of poles (e.g., a 6-pole winding) and a second or high frequency winding having a second number of poles (e.g., an 8-pole winding), wherein the low and high frequency windings can be formed in a common stator lamination. As will be appreciated, the number of poles are merely exemplary, and more or fewer poles may be implemented without departing from the scope of the invention. In operation, the low frequency winding is energized in a first frequency range, and the high frequency winding is energized in a second frequency range. While the invention is described with respect to a dual wound motor, it should be appreciated that the motor may contain three or more sets of windings to further tune the motor operation.

Splitting the operation frequency range among multiple windings is beneficial, for example, in that the efficiency of the motor can be increased throughout the operation frequencies. In other words, the use of multiple windings enables the motor to have multiple synchronous speed ranges. These multiple speed ranges allow the designer to more precisely tune the motor to the application requirements, thereby also allowing the motor to operate with less slip. Another benefit of splitting the operation frequency among multiple windings is that motor can be selected to more closely match the power requirements of the application (i.e., the motor need not be oversized to the same degree as conventional variable frequency motor based systems) and, thus, the power factor is increased in the low frequency range relative to conventional systems, which decreases power consumption.

Preferably, the low frequency winding is energized from the minimum operation frequency to about a midpoint of the overall frequency range, and the high frequency winding is energized from about the midpoint of the overall frequency range to the maximum operation frequency. For example, if the operating frequency range is 360 Hz to 800 Hz, the low frequency winding is energized from 360 Hz to about 560 Hz, and the high frequency winding is energized from about 560 Hz to 800 Hz. The frequency ratio for each set of windings is thereby reduced from 2.2 (800/360) to 1.56 (560/360) and 1.43 (800/560) for the low speed windings and high speed windings, respectively.

The invention will now be described in more detail with respect to several embodiments. Because the invention was conceived and developed for use in the aerospace industry, it will be herein described chiefly in this context. However, the principles of the invention in their broader aspects can be adapted to other industries that utilize a multi-speed pump powered by variable frequency AC power.

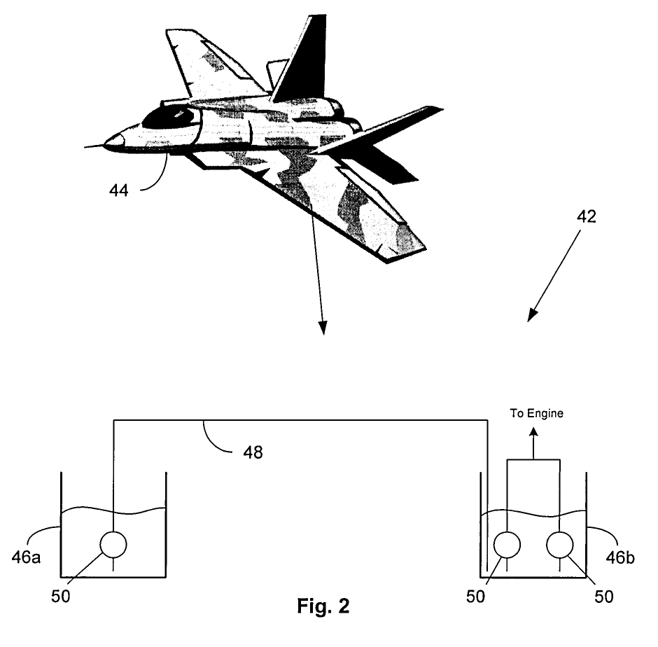

Referring to FIG. 2, there is shown a simplified schematic diagram of an exemplary fuel system 42 for an aircraft 44. The fuel system 42 may include a first fuel storage tank 46a and a second fuel storage tank 46b, wherein the respective storage tanks may be coupled to one another by fuel line 48 and fuel pump 50, which may be located within the first fuel tank 46a. The exemplary fuel pump 50 can be used to transfer fuel from the first storage tank 46a to the second storage tank 46b. Further, additional fuel pumps 50 can be used to transfer fuel from the fuel tank 46b to the engine (not shown). As will be appreciated, there may be a number of pumps utilized in the aircraft, and FIG. 2 is merely exemplary of one application of an aircraft fuel pump.

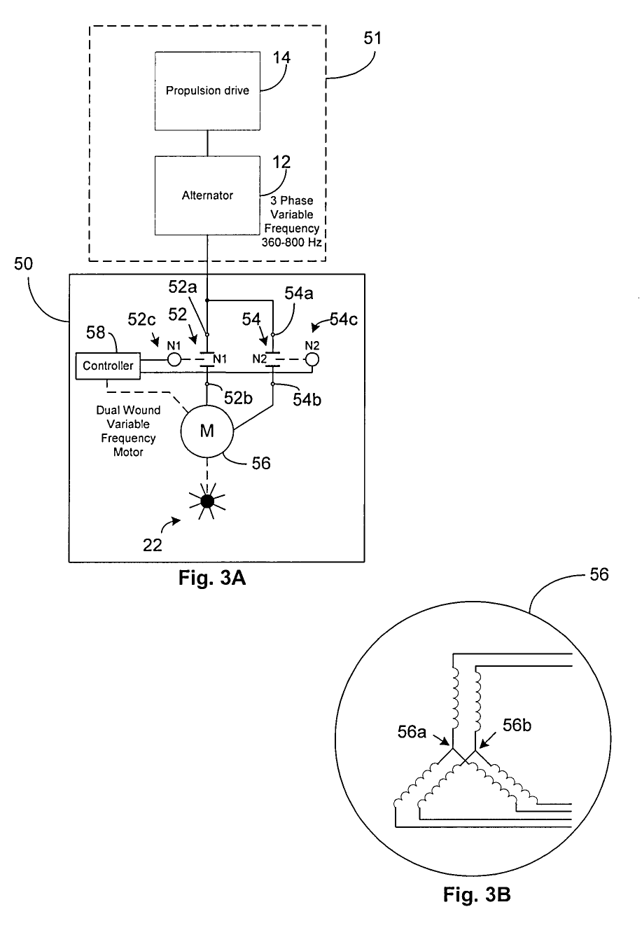

Moving now to FIG. 3A, there is shown an exemplary aircraft fuel pump 50 coupled to a variable frequency power supply 51, wherein the power supply 51 includes an alternator 12 driven by a propulsion system 14 as described previously. The variable frequency power supply 51 provides three phase AC power that varies between a first frequency F1 and a second frequency F2, wherein the ratio F2/F1 can be 2:1 or greater. For example, the first frequency F1 can be 360 HZ, while the second frequency F2 can be 800 Hz.

A first connection 52a of a low frequency contactor 52 and a first connection 54a of a high frequency contactor 54 are electrically coupled to the variable frequency power supply 51. Further, a second connection 54b of the low frequency contactor is electrically coupled to a first or low frequency winding 56a (FIG. 3B) of the dual-wound variable frequency motor 56, while the second connection 54b of the high frequency contactor 54 is electrically coupled to a second or high frequency winding 56b of the dual-wound variable frequency motor 56.

Each winding 56a and 56b of the motor 56 is optimized for a specific operation range. For example, the first winding 56a of the motor 56 can be optimized for low frequency operation, while the second winding 56b of the motor 56 can be optimized for high frequency operation. More specifically, the low frequency winding 56a may be designed such that the motor's power factor (PF) is relatively high in the low speed or low frequency range (compared to conventional pump motors), thereby minimizing power consumption of the motor. Further, the first winding 56a may be designed such that motor slip is reduced or minimized near the minimum frequency F1, and allowed to increase (e.g., to about 20-25% slip) near the predetermined transition point (e.g., the midpoint of the frequency range or about 560 Hz in the present example). Similarly, the second winding 56b may be designed such that the PF is relatively high in the high speed or high frequency range (compared to conventional variable frequency pump motors), while motor slip is reduced or minimized near the transition point and allowed to increase (e.g., to about 20-25% slip) near the maximum frequency F2. In other words, the motor slip at the low end of the respective frequency ranges is less than the motor slip at the high end of the respective frequency ranges. Design of motor windings is well known by those skilled in the art and the specifics related achieving desired performance characteristics over a given operation range will not be described herein.

The contactors 52 and 54 are activated and deactivated (i.e., opened and closed) by relays 52c and 54c, respectively, which in turn are operatively coupled to a controller 58. The controller 58 determines which winding 56a or 56b should be energized based on monitored motor conditions and/or frequency output of the power supply 51. Via the relays 52c and 54c, the controller 58 energizes the appropriate contactor 52 or 54 so as to energize the first winding 56a or the second winding 56b. For example, when the controller 58 applies a voltage to the relay 52c, the contactor 52 will close thereby energizing the first winding 56a, and when the controller 58 removes the voltage from the relay 52c, the contactor 52 will open thereby de-energizing the first winding 56a. As an alternative to relays, solid state switches may be used to energize the respective contactors 52 and 54. Such solid state switches may be integrated within a controller and may be in the form of contact outputs or semiconductor driven outputs, for example.

Additionally, the controller 58 is operatively coupled to the motor 56 so as to monitor motor parameters, such as speed, frequency, torque, voltage and/or current, for example. An output shaft of the motor 56 is coupled to an input shaft of the pump 50, which is operatively coupled to a fluid driving mechanism, such as an impeller 22, for example.

It is noted that while the pump is described with respect to having an impeller for driving the fluid, the invention is not limited to such a pump, and may be used with any pump that moves or pressurizes a fluid. The pump may be a dynamic pump or a positive displacement pump. Exemplary pumps include a centrifugal pump, liquid ring pump, regenerative pump, diaphragm or membrane pump, piston pump, hydraulic ram, screw pump, rotary vane pump, gear pump, lobe pump, circumferential pump, progressive cavity pump, inductive pump, etc.

Additionally, while the contactors 52 and 54 and the controller 58 are shown as part of the pump 50, these components may be external to the pump 50. For example, the contactors 52 and 54 and controller 58 may be part of the aircraft power system 51. Further, the controller 58 may be integrated within the relays 52c and 54c of the contactors 52 and 54, e.g., a solid state or smart relay.

In the exemplary pump of FIG. 3A, the controller 58 is a microprocessor based controller that executes predefined instructions, as will be described in more detail below. As will be appreciated, the controller 58 may be embodied in other forms, and a microprocessor based controller is merely exemplary. For example, the controller 58 may comprise discrete circuits that perform functions analogous to those performed by the microprocessor based controller.

The controller 58 is configured so as to energize the low frequency relay 52c when the motor frequency is at or below a predetermined threshold, and to energize the high frequency relay 54c when the motor frequency is above the predetermined threshold. For example, the controller 58 may energize the low frequency relay 52c and de-energize the high frequency relay 54c when the motor frequency is at or below 560 Hz, thereby energizing the low frequency winding 56a. When the motor frequency is greater than 560 Hz, the controller 56 de-energizes the low frequency relay 52c and energizes the high frequency relay 54c, thereby energizing the high frequency winding 56b. Thus, the operating frequency range is split among the multiple windings, as opposed to over a single winding as is done in conventional pump systems.

By splitting the operating range of the motor 56 over multiple windings, the frequency ratio that the respective windings 56a and 56b is operate in is reduced, which results in higher efficiency (less slip), higher power factor and less power consumption. For example, assuming that the variable frequency signal provided by the power source 51 is 360 Hz to 800 Hz, a conventional 6-pole variable speed AC motor has synchronous speed range of 7200 RPM to 16000 RPM. The motor is oversized to provide the necessary power output throughout the entire frequency range, otherwise it will have excessive slip at high frequency. However, an oversized motor results in a low power factor in the low frequency range, which increases power consumption. Further, the high synchronous speed (16000 RPM) causes the pump to create high hydraulic pressure (recall that pressure in a centrifugal pump is proportional to the square of speed) and, thus, if the motor operates at or near the synchronous speed, the high hydraulic pressure causes the motor to draw high current (i.e., high power consumption). To minimize the high pressure and current draw at high frequencies, the conventional motor is designed to have high slip in the upper frequency range (e.g., about 45% slip), which brings the actual motor speed to about 9000 RPM. However, the high slip reduces the efficiency of the motor (i.e., the percentage of the input power that is actually converted to work output from the motor shaft) in the high frequency range, which is undesirable.

In contrast, the first winding 56a of the dual wound motor 56 can be designed to operate in a first frequency range of 360 Hz to 560 Hz, and the second winding 56b of the dual wound motor 56 can be designed to operate in a second frequency range of 560 Hz to 800 Hz. Thus, the motor 56 can have two different synchronous speed ranges, e.g., a first synchronous speed range between 7200 RPM and 11200 RPM (360 Hz to 560 Hz), and a second synchronous speed range between 8400 RPM to 12000 RPM (560 Hz to 800 Hz).

In present example, the frequency ratio for each winding 56a and 56b of the motor 56 is about 1.5:1, which is significantly less than the frequency ratio for the exemplary conventional motor (i.e., 2.22:1). Therefore, the motor 56 need not be oversized to the same extent as the conventional motor, which results in a higher power factor in the low frequency range. Further, since the high frequency winding produces a maximum synchronous speed (12000 RPM) that is significantly lower than the maximum synchronous speed (16000 RPM) of the conventional motor, the motor slip can be reduced (e.g., motor slip can be about 25% for the motor 56, compared to 45% for the conventional motor), thereby increasing motor efficiency.

Thus, by reducing the frequency ratio for each winding, the efficiency and power factor can be increased, resulting in less input power to the motor. Further, the motor can be designed for less slip (e.g., on the order of 25% or less). In contrast, pump driven by a conventional 6 pole variable frequency motor, which must operate over the entire frequency range (360-800 Hz), typically is designed to have upwards of 45% slip at 800 Hz.

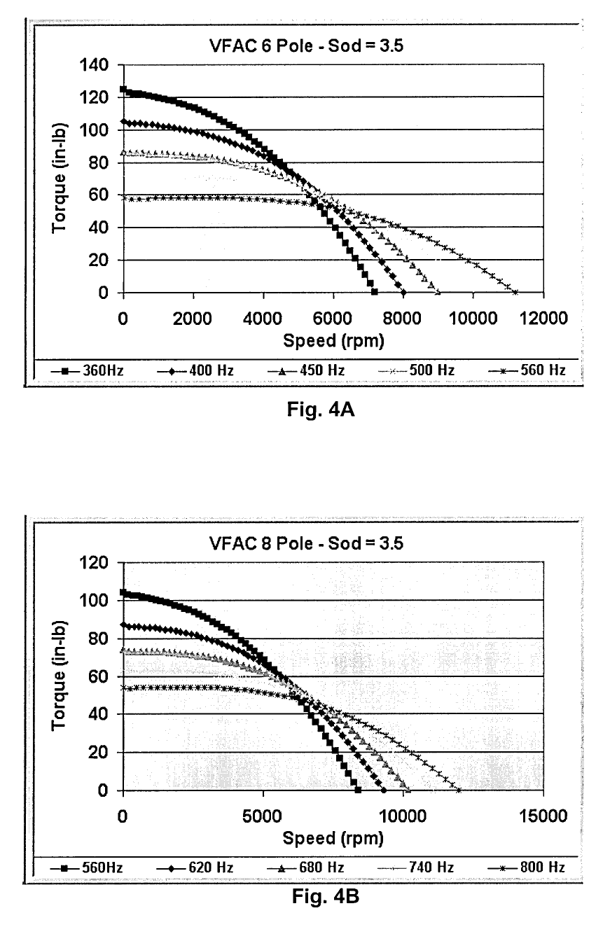

Referring now to FIGS. 4A and 4B, there are shown torque vs. speed curves for an exemplary dual wound motor 56 having a stator outer diameter (Sod) of 3.5 inches, wherein FIG. 4A corresponds to the first winding 56a of the motor 56, and FIG. 4B corresponds to the second winding 56B of the motor 56. As can be seen in FIGS. 4A and 4B, the intersection of the curves in each graph occur at about the same torque and speed (e.g, at about 5900-6600 RPM and about 45-50 in-lbs.). Since it is desirable to minimize shock and/or surge to the motor and pump when switching between windings, it is preferable to switch between the windings when motor operating conditions for the respective windings are similar or overlap. In other words, it is preferable to switch between windings when motor speed for the first winding is substantially the same as motor speed for the second winding at a given operating frequency. Alternatively, or in conjunction with motor speed, switching between the first and second windings can occur when motor current (or motor torque) for the first winding is substantially the same as motor current (or motor torque) for the second winding at a given operating frequency. As used herein, substantially the same motor speed refers to a motor speed within about +/−500 RPM or about 10 percent maximum operation speed of the motor, and substantially the same motor current (or torque) refers to about 10% of maximum operation current (or torque).

As can be seen, FIGS. 4A and 4B indicate that the low and high frequency windings produce about the same torque and speed at about 5900-6600 RPM. Thus, this exemplary motor is suitable for driving a pump at a speed of about 5900 to 6600 RPM. As will be appreciated, the motor can be designed to operate at other speeds, and the graphs of FIGS. 4A and 4B are merely exemplary of one motor.

As was noted above, the controller 58 can be microprocessor based and can include a microprocessor circuit having a processor and memory. Further, code is stored in memory and, when executed by the processor, causes the processor to select between the first winding 56a or the second winding 56b based on predefined criteria. The executed code can implement a comparator function, wherein a motor parameter is compared to a predetermined parameter and, based on the comparison, a selection between the first 56a or second 56b winding is made. For example, the controller 58 can monitor the actual frequency of the motor 56 in Hz. If the actual frequency is below or equal to a predetermined value, such as 560 Hz, the processor can provide a voltage (e.g., via a digital output—not shown) to the low frequency relay 52c, and if the frequency is above 560 Hz the processor can remove the voltage from the low frequency relay 52c and provide a voltage (e.g., via a different digital output—not shown) to the high frequency relay 54c. Preferably, the code executed by the processor includes a hysteresis circuit to prevent continuous switching between the low and high frequency relays near the threshold level (e.g., 560 Hz).

It is noted that the transition point between the low frequency relay 52c and the high frequency relay 54c need not be the midpoint of the operating frequency range, but can be any point within the operating range of the motor 56. Preferably, the transition point between low and high frequency relays 52c and 54c (and thus between the first and second windings 56a and 56b) is chosen such that the motor operating characteristics for both windings are similar or overlap. In other words, it is preferable that the current draw, motor torque, electrical power, and/or motor rotational speed at the chosen transition point be approximately the same for both windings so as to minimize shock and/or surge to the motor 56 and/or pump 50.

Accordingly, the present invention enables a pump to be simply, efficiently and reliably operated on a variable AC power source over a wide frequency range. Further, the pump can operate with a relatively high power factor and can have a relatively high efficiency over the entire frequency range compared to conventional pumps. The pump incorporates minimal electronics and as a whole weighs significantly less than previous systems that employed constant speed drives or motor controllers.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electrically operated pump assembly operable on a variable frequency power source, said power source producing power in a predetermined frequency range, comprising:
a pump having an input shaft;
a variable frequency motor operatively coupled to the input shaft, the variable frequency motor comprising a first winding having a first number of poles, and a second winding having a second number of poles, wherein the first winding is selectively energizable in a first frequency range of the predetermined frequency range, and the second winding is selectively energizable in a second frequency range of the predetermined frequency range.

2. The pump assembly of claim 1, further comprising a controller for selecting the first winding or the second winding.

3. The pump assembly of claim 2, wherein the controller is responsive to a motor operating parameter so as to select between the first winding or the second winding.

4. The pump assembly of claim 2, further comprising:
a first contactor for selectively coupling the first winding to the power source; and
a second contactor for selectively coupling the second winding to the power source,
wherein the controller is operatively coupled to the first contactor and the second contactor, and the controller is configured to selectively operate the first contactor or the second contactor based on a predetermined motor parameter.

5. The pump assembly of claim 2, wherein the controller is a microprocessor based controller.

6. The pump assembly of claim 2, wherein the controller is integrated in a solid state relay.

7. The pump of claim 6, wherein the solid state relay includes a monitoring circuit for monitoring a motor parameter, and wherein selection of the first winding or the second winding is based on the monitored parameter.

8. The pump of claim 2, wherein the first winding and the second winding have an overlapping operating range, and the controller selects between the first winding or the second winding while the motor is in the overlapping operating range.

9. The pump of claim 2, wherein selection of the first winding or the second winding is based on at least one of motor speed, motor frequency, electrical power, motor torque, or motor current.

10. The pump of claim 2, wherein the controller is configured to select between the first winding or the second winding when motor speed, motor torque and/or motor current are substantially the same for the respective windings.

11. The pump of claim 1, wherein the motor maintains a relatively constant speed throughout the entire frequency range.

12. An electrically operated pump assembly operable on a variable frequency power source, said power source producing power in a predetermined frequency range, comprising:
a pump means for pumping a fluid;
a variable frequency motor operatively coupled to the pump means, the variable frequency motor comprising a first winding having a first number of poles, and a second winding having a second number of poles, wherein the first winding is selectively energizable in a first frequency range of the predetermined frequency range, and the second winding is selectively energizable in a second frequency range of the predetermined frequency range; and
a controller means for selecting between the first winding and the second winding.

13. The pump assembly of claim 12, further comprising:
a first selection means for selectively coupling the first winding to the power source; and
a second selection means for selectively coupling the second winding to the power source,
wherein the controller means is operatively coupled to the first selection means and the second selection means, and the controller means is configured to selectively operate the first selection means or the second selection means based on a predetermined motor parameter.

14. A method of driving a pump via a multi-wound variable frequency electrical motor operable on a variable frequency power source, said variable frequency power source producing power in a predetermined frequency range, comprising:
providing variable frequency power to the multi-wound variable frequency electrical motor;
selectively energizing a first winding of the motor in a first frequency range of the predetermined frequency range;
selectively energizing a second winding of the motor in a second frequency range of the predetermined frequency range.

15. The method of claim 14, further comprising:
monitoring at least one motor parameter;
comparing the monitored parameter to a predefined value; and
energizing the first winding or the second winding based on the comparison.

16. The method of claim 15, wherein comparing the monitored parameter to a predefined value includes selecting the predefined value so as to minimize mechanical and/or electrical shock to the pump and/or motor.

17. The method of claim 16, wherein minimizing mechanical and/or electrical shock includes selecting the predefined value such that motor speed, motor torque and/or motor current corresponding to the first winding is substantially the same as motor speed, motor torque and/or motor current corresponding to the second winding.

18. The method of claim 15, wherein the motor parameter is at least one of motor speed, motor frequency, electrical power, motor torque or motor current.

19. The method of claim 14, further comprising tapering motor slip within a respective frequency range.
